(19) United States
(12) Patent Application Publication
(10) Pub. No.: US 2013/0192017 A1
(43) Pub. Date: Aug. 1, 2013

(54) PUMPED DRAIN AND DEFROST WINDSHIELD WIPER SYSTEM

(71) Applicant: Lawrence Jacobowitz, Boynton Beach, FL (US)

(72) Inventor: Lawrence Jacobowitz, Boynton Beach, FL (US)

(21) Appl. No.: 13/364,243

(22) Filed: Feb. 1, 2012

(51) Int. Cl. B60S 1/32; B60S 1/54; B60S 1/34

(52) U.S. Cl. 15/250.361; 15/250.06; 15/250.48; 15/250.202

(57) ABSTRACT

A windshield wiper including: a housing including a blade mounted therein; at least one drain tube including a plurality of inlets; and a coupler for coupling the at least one drain tube to a pump. A system incorporating the windshield wiper and vehicles having the system installed are disclosed.

### BACKGROUND OF THE INVENTION

1. Field of the Invention

The present invention relates to motor vehicles, and more particularly to improved windshield wiping methods and apparatus.

2. Description of the Related Art

For the many advances in automotive technology, there have been surprisingly few advances assuring visibility during precipitation driven by truly inclement weather. That is, since the invention of windshield wipers in 1903, over a century has passed without a solution that can provide users with adequate clearing of heavy rain, ice or snow. In order to provide some context, aspects of a prior art windshield wiper are introduced.

Referring to FIG. 1, there is shown a prior art windshield wiper 1. The prior art windshield wiper 1 includes a blade 2. The blade 2 is generally fabricated from rubber, a soft polymer or other similar material that provides for a “squeegee” action. That is, an action that sipes water away from an exterior surface of a windshield (i.e., expels water from the surface). The blade 2 is attached to a spine 3. The spine 3 provides a rigidity required to ensure downward pressure which is delivered through an arm 7 and upon the blade 2 is effectively communicated along a length, L, of the prior art windshield wiper 1. In common embodiments of the prior art windshield wiper 1, the pressure is evenly distributed through a suspension system that includes components such as at least one primary armature 4 and often a secondary armature 5. As is commonly recognized, the secondary armature 5 often includes a single coupling 6 for coupling of the prior art windshield wiper 1 to the arm 7. The arm 7 is driven by a motor and mechanical assembly (not shown) which provides for repetitive travel of the prior art windshield wiper 1 across a viewing area of the windshield.

Present day windshield wipers 1 are generally useful in limited to light rain and are often inadequate to handle a large volume of rain, such as during intense downpours. In intense rainstorms, wiper blades are unable to displace the high volumes of water. Generally, the wipers smear the rain into blurring sheets and create very limited visibility through the windshield. Increasing the speed of the traverse of the wiper has been useful, but this also causes limitations in visibility. Further, high speeds can cause excessive wear to a wiper system. These problems have been persistent in the auto industry for over a century. Other problems with present day windshield wipers 1 are known.

For example, while windshield defrosters can help in freezing weather, present day internal, in-cab, heated and fan blown air windshield defrosters are manifestly ineffective in melting ice deposited on surfaces of the prior art windshield wiper 1. Any one that has driven in icing weather recognizes that the glass windshield is a poor thermal conductor for heat transfer to the squeegee blade of the typical windshield wiper. At low ambient temperatures, ice forming on the various parts of the prior art windshield wiper 1 results in dangerously poor visibility for automobile, bus and truck drivers alike.

Various attempts have been made to address icing of wiper blades. Among these are designs that conduct heat to the wiper blade 2. However, efforts involving conduction heating are inefficient and generally ineffective. That is, as silicone rubbers and synthetic polymer equivalents used in wiper squeegees are good thermal insulators, the designs fail to perform as intended.

That is, the prior art has been unable to solve the problems associated with the thermal insulator property of flexible rubber or polymer windshield wiper blades. The thermodynamics of heat transfer are poorly realized in prior art implementations which teach embedding wires into channels opened into the thermally insulating wiper blade body. Considering the radiation emission pattern of a wire to be that of a cylindrical isotropic radiator, the majority of the heat energy is lost into directions not effective for melting ice on the blade-edge and sidewalls.

Some other efforts have addressed the thermal conductivity limitation by additions of carbon-based materials such as carbon-fibers or graphite or nanoparticle admixtures in the materials used in the blade 2. These solutions enhance thermal conductivity with an attendant increase in the cost of materials. Notably all polymer and rubber materials suffer diminished lifetimes resulting from conductive thermal cycling associated with heating and cooling of the blade.

Likewise, embedded resistive wires into the wiper blades (i.e., heating thermal insulators) reflects an attempt to overcome the fundamental physics involved. For the same reason, conduction heating of insulators is inappropriate. Heated windshield fluids through capillary tubes have been reported to have caused fires or burn injuries.

With the millions of drivers on the road today, and the frequent presentment of rain and snow hazards, an improved windshield wiper is of great need. The improvements should be cost effective, and be equipped to limit the impact of precipitation for the variety of inclement conditions that confront driver's around the world.

### SUMMARY OF THE INVENTION

In one embodiment, the invention includes a windshield wiper including: a housing including a blade mounted therein; at least one drain tube including a plurality of inlets; and a coupler for coupling the at least one drain tube to tubing that leads to a pump.

In another embodiment, the invention includes a system for wiping a windshield, the system including: at least one windshield wiper including a housing with a blade mounted therein; at least one drain tube including a plurality of inlets; and a coupler for coupling the at least one drain tube to tubing that leads to a pump; and a pump for applying a negative pressure to the at least one drain tube and pumping precipitation from the windshield.

In a further embodiment, the invention includes a vehicle including a system for wiping a windshield, the vehicle including: a windshield; and at least one windshield wiper including a housing with a blade mounted therein; at least one drain tube including a plurality of inlets; and a coupler for coupling the at least one drain tube to tubing that leads to a pump; and a pump for applying a negative pressure to the at least one drain tube and pumping precipitation from the windshield; wherein the at least one windshield wiper is mounted to the vehicle for providing wiping of precipitation from the windshield during operation of the vehicle.

### BRIEF DESCRIPTION OF THE DRAWINGS

The foregoing and other features and advantages of the invention are apparent from the following detailed description taken in conjunction with the accompanying drawings in which:

FIG. 1 provides a perspective view of a prior art windshield wiper;

FIG. 2 is a perspective cutaway view of a windshield wiping system disclosed herein;

FIG. 3 is a side cutaway view of the windshield wiper of FIG. 2;

FIG. 4 is a perspective cutaway view of a collector included in the windshield wiper of FIG. 2;

FIG. 5 is a side cutaway view of another embodiment of the windshield wiper disclosed herein;

FIG. 6 is a perspective cutaway view of the windshield wiper of FIG. 5;

FIG. 7 is a perspective cutaway view of components included in the windshield wiping system;

FIG. 8 is a side cutaway view of the windshield wiper disclosed herein;

FIGS. 9, 10 and 11 are control diagrams for controlling the windshield wiper system; and

FIGS. 12, 13 and 14 are diagrams of additional embodiments of a connector for the windshield wiper.

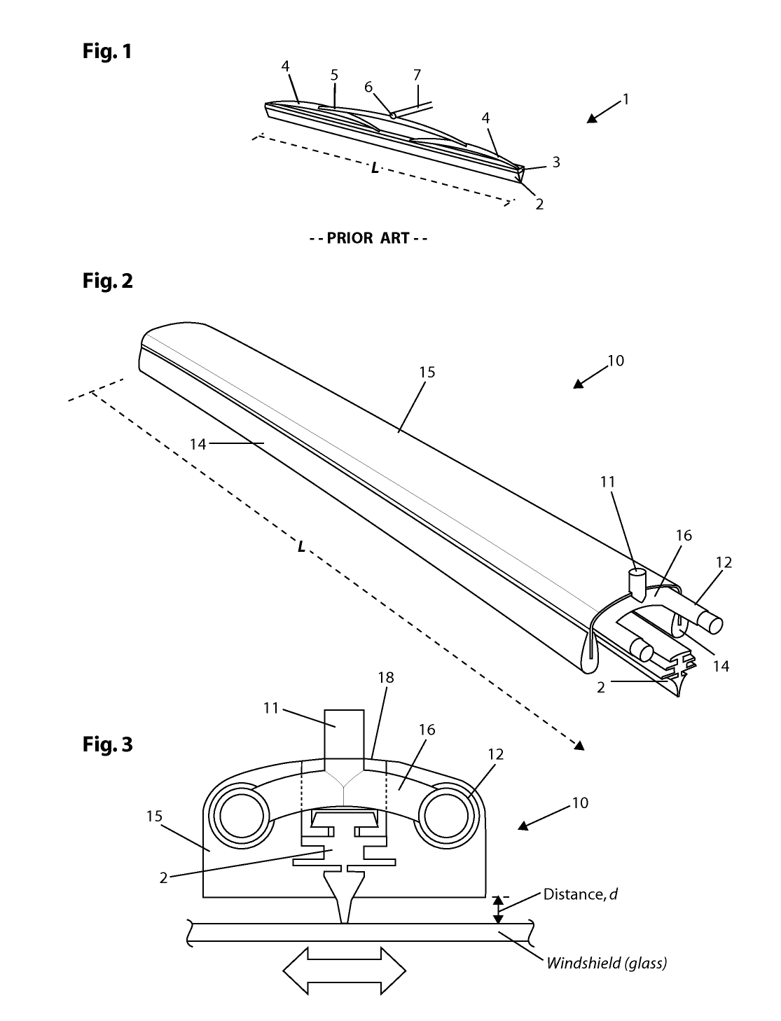

### DETAILED DESCRIPTION OF THE INVENTION

Disclosed herein are an improved windshield wiper, windshield wiping system and methods for making use of the various components. Among other things, the teachings herein provide for efficiencies not previously realized. For example, the teachings herein provide for effective heating of an exterior surface of a windshield as well as active removal of excess water as may be realized in torrential rain.

As an overview, the windshield wiping system according to the teachings herein provides for active removal and control of precipitation deposited onto a windshield. The windshield wiper includes components for, among other things, pumping away the precipitation. In some embodiments, the windshield wiper (also referred to as the “wiper,” or as a “squeegee”) includes heating elements for actively heating during operation.

Referring now to FIG. 2, there is shown a cutaway view of an exemplary windshield wiper 10. In this example, the windshield wiper 10 includes a housing 15. The housing 15 is of a length, L, that is generally equivalent to the length, L, of a prior art windshield wiper 1. The housing 15 serves to include components of the windshield wiping system. Exemplary components included with the housing 15 include the blade 2, at least one drain tube 12, and a coupler 11. Generally, the coupler 11 serves to provide fluidic connection to an external supply of positive or negative pressure, and may further provide for physical attachment of the windshield wiper 10 to the arm 7. In some embodiments, the coupler 11 is integrated into each of the at least one drain tube 12. For example, each drain tube 12 may include the coupler 11, where the coupler 11 is disposed along a side of the drain tube 12 or on one end (such as a lower end) of the drain tube 12.

In other embodiments, the coupler 11 may be a part of a connector 16. The connector 16 may be any one of a variety of embodiments. In the embodiment shown, the connector 16 is an H-connector that provides for interconnection of two generally parallel drain tubes 12. Each of the drain tubes generally runs along the length, L, of the housing 15, with the blade 2 disposed between the two drain tubes 12. In the embodiment depicted, the housing 15 includes at least one additional grommet 14. Each of the grommets 14 are disposed along a wall of the housing 15 and provide for, among other things, protection of the windshield from scratching by the housing 15. Like some other components of the windshield wiper 10, the at least one grommet 14 may be continuous substantially along the length, L, or may be segmented along the length, L.

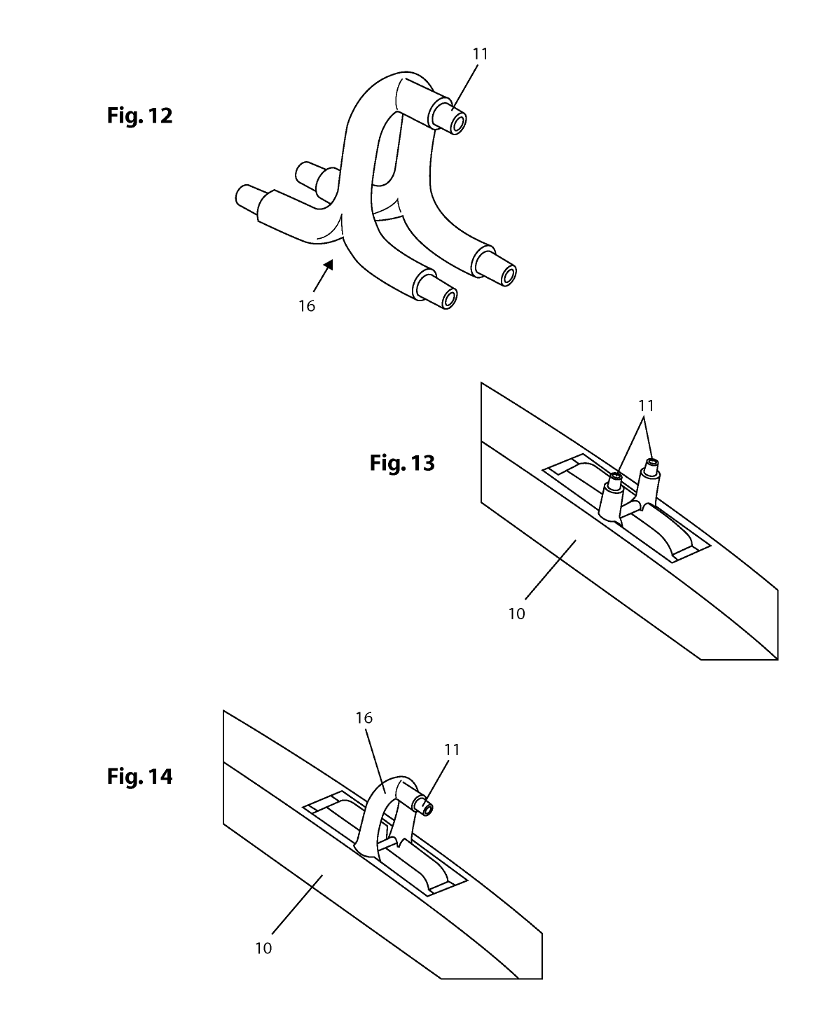

In some embodiments, the connector 16 is disposed in approximately the center of the length, L, of the housing 15. Advantageously, this provides for efficient balancing of intake into each of the drain tubes 12. In embodiments involving other configurations of drain tubes 12, the connector may include other configurations. That is, for example, in an embodiment making use of a single drain tube 12, the connector 16 may appear as an inverted “T” form. Additional embodiments of the connector 16 are illustrated in FIGS. 12-14, and discussed further below.

The housing 15 may be coupled to the arm 7 using a prior art connecting device, or through some other form of connection. For example, a combination mechanical/fluidic connection may be used (such as with the coupler 11). In embodiments making use of a prior art connection to the arm 7, fluidic connection to the coupler 11 may be accomplished via tubing run internally through the arm 7.

The housing 15 may be fabricated in any manner deemed suitable according to standards employed by a manufacturer, designer, user or other similar party. For example, the housing 15 may be a unitary structure, such as injection molded plastic, assembled from various parts (such as by gluing or welding). The housing 15 may be assembled from segmented parts, include at least one hinge (such as along the length, L) or include other similar devices. In short, known or later devised manufacturing techniques and apparatus may be used to provide for the housing 15. In general, the housing 15 is fabricated so as to provide for desired rigidity and conformity with the windshield, as well as to provide an integrated structure for containing the components disclosed herein.

In the non-limiting examples provided, the housing 15 is of a generally U-shaped cross section. However, the housing 15 may be of other embodiments, for example, the housing 15 may be of an inverted V-shape. Combinations of profiles (i.e., cross sections) may be used such that one form merges or transforms into another form when taking cross sectional views along the length, L.

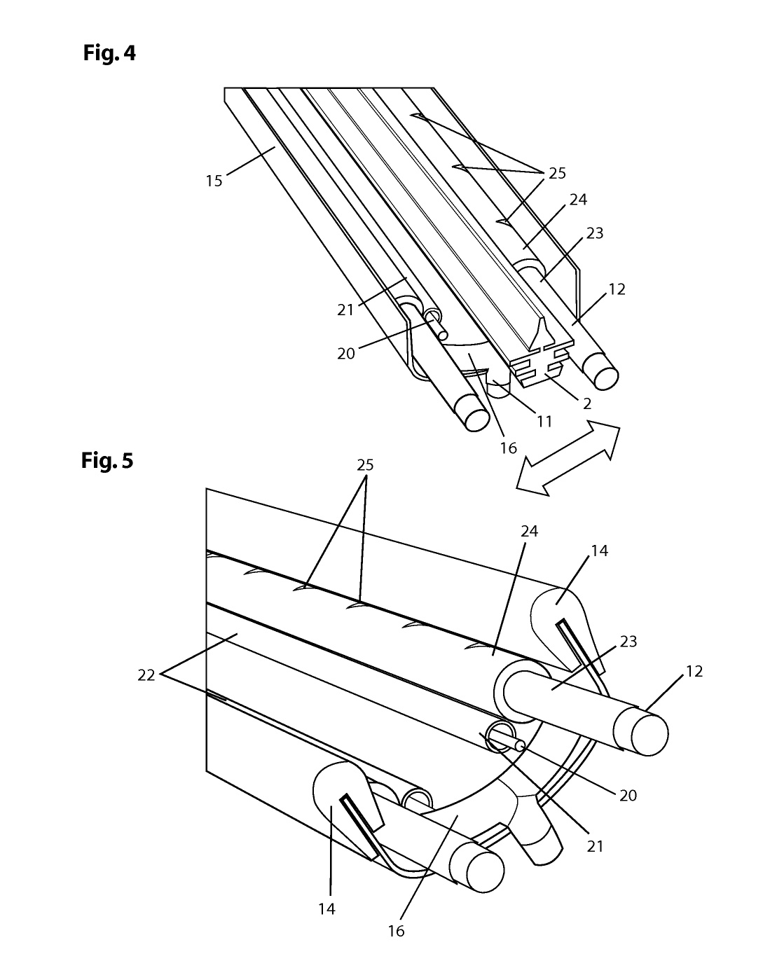

Referring now also to FIG. 3, there is shown a cross-sectional view of an exemplary embodiment of the windshield wiper 10. In this example, the housing 15 is shown as generally being of an inverted “U” shape. The housing 15 includes the blade 2 which is substantially of the same length, L, as the housing 15. The blade 2 is coupled to the housing 15 by at least one mount 18. The mount 18 may be integrated into the housing 15 at the time of manufacture of the housing 15 or added after manufacture of the housing 15. The mount 18 may also be substantially of length, L. In other embodiments, a plurality of low-profile mounts 18 (i.e., short in consideration of the length, L) may be included (e.g., three to five or so mounts 18). The at least one mount 18 may rely on a variety of mounting techniques. For example, each mount 18 may be a clip, a retainer or the like. More specifically, where the mount 18 is a retainer, the mount 18 may include an open profile into which the blade 2 is inserted (as shown in FIG. 3). In these embodiments, the mount 18 may rely on friction-fitting to ensure retention of the blade 2. In short, the mount 18 provides for mounting of the blade 2 to the housing 15 in a manner that provides for retention of the blade 2 as well as desired operational performance of the blade 2.

As shown in FIG. 3, when the windshield wiper 10 is assembled and installed, the blade 2 contacts the windshield. Generally, a height of the blade 2 is such that the housing 15 is suspended above the windshield by some distance, D. Among other things, including an offset of distance, D, ensures adequate wiping action will occur. It is recognized that in practice the housing 15 may rotate slightly or that the blade 2 may compress (under certain conditions), thereby eliminating the offset on at least one side of the housing 15. Accordingly, the at least one grommet 14 ensures the windshield is not scratched by the housing 15, and may provide for additional wiping action. In embodiments where the grommet 14 is segmented (not shown), the grommet 14 (which is then actually a plurality of shortened grommets 14) provide for some wiping, scratch relief and some flow control where precipitation is directed into the housing 15 as the wiper 10 wipes. That is, for such embodiments, there may be an open space between each of the plurality of shortened grommets 14.

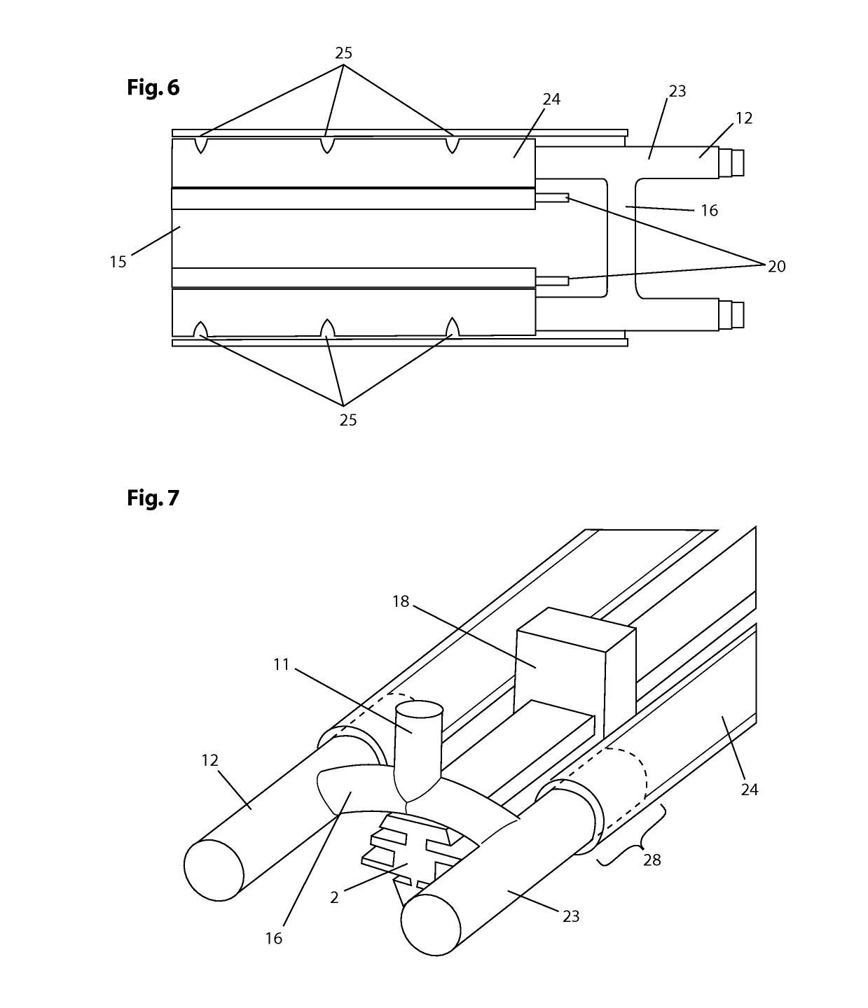

Referring now to FIGS. 4 and 5, an underside of the wiper 10 is shown. In these examples, it may be seen that each of the drain tubes 12 includes a pipe 24. Each of the pipe 24 is mated with a leg 23 of the H-connector. Each of the pipes 24 generally includes a plurality of inlets 25 which face an exterior wall of the housing 15 (i.e., are outward facing). When the windshield wiper 10 is in operation (thus travelling back and forth in directions indicated by the directional arrow), the outlets lead the wiper 10 into the precipitation. As will be discussed later herein, a negative pressure pulled on each of the pipes 24 draws the precipitation into the inlets 25 of the drain tubes 12 and out through the coupler 11. However, for purposes of introduction, pumping may be controlled manually, in a dogmatic fashion (such as where it is adjusted according to another parameter, such as wiping speed), through computer control (such as with input from a rain sensor on board the vehicle) or by other techniques deemed appropriate.

Generally, each drain tube 12 is surrounded by the pipe 24. In some embodiments, the drain tube 12 provides rigidity, while pipe 24 provides for improved siping action (i.e., may also wipe the precipitation, at least to an extent. For example, each of the drain tubes 12 may be fabricated from a rigid material, such as PVC, while each pipe 24 may be fabricated from a softer material, such as rubber, neoprene or the like.

The inlets 25 may be provided on an outer side of the pipe 24/drain tube 12, as is generally shown. In other embodiments, the inlets 25 may be included on an inner side (such as near the blade 2). In some embodiments, the inlets 25 are manifested as a plurality of patterned perforations in the pipe 24/drain tube 12. In general, the inlets 25 provide for fluidic communication (e.g., pick-up) along a length of the wiper 10, and the size, design and placement of the inlets 25 may accommodate this purpose (among others).

Note that FIGS. 4, 5 and 6 provide inverted views of the windshield wiper 10. In FIGS. 5 and 6, the blade 2 is omitted, merely for simplicity and to better illustrate other components.

Also shown in the embodiments of FIGS. 4 and 5 are heating elements. Specifically, in these embodiments, at least one resistive element 20 is disposed in sheathing 21 to provide for at least one heater 22 (i.e., a resistive heater). The sheathing 21 may be formed of at least one of insulation disposed around a commercially available resistive element and a tube for insertion of the resistive element 20. In the examples shown, there are two heaters 22, each heater 22 being disposed along an opposing side of the blade 2. As will be discussed in greater detail herein, each of the heaters 22 may be controlled manually, thermostatically or through other techniques deemed appropriate.

It should be noted that the at least one drain tube 12 and the at least one heater 22 are generally oriented within the housing 15 to provide for efficient functionality. That is, for example, each of the at least one drain tubes 12 is oriented in the housing 15 such that it is proximal to the windshield. In this manner, each of the inlets 25 is oriented to receive precipitation from a surface of the windshield.

Advantageously, use of the resistive element 20 within the housing 15 provides for effective radiative heating and efficiently melting frozen precipitation. That is, unlike prior art solutions where resistive elements are used, a substantial portion of the energy is directed to the precipitation, and is not lost in heating components of the (prior art) windshield wiper.

Other embodiments of the heater 22 may be used. For example, in another embodiment (not shown), the heater 22 makes use of hot air pumped (i.e., a forced hot air heater) to the sheathing 21 and distributed through a plurality of outlets. In this embodiment, the heating components are similar in construction to the components used for pumping away precipitation, with the exception being that the pumping provides a positive pressure.

Refer now to FIGS. 6 and 7, where additional cutaway views of the windshield wiper 10 are shown. In particular, note that FIG. 7 shows the mount 18 as a discrete retaining mount 18. Also, the leg 23 of the H-connector is mated with the pipe 24 in a mating region 28. Mating in the mating region 28 may rely simply on friction-fitting of the pipe 24 over the leg 23, or may include adhesive, glue, bonding or the like. In some embodiments, the H-connector and each of the pipes 24 are provided as a unitary component (thus, there is no mating region 28).

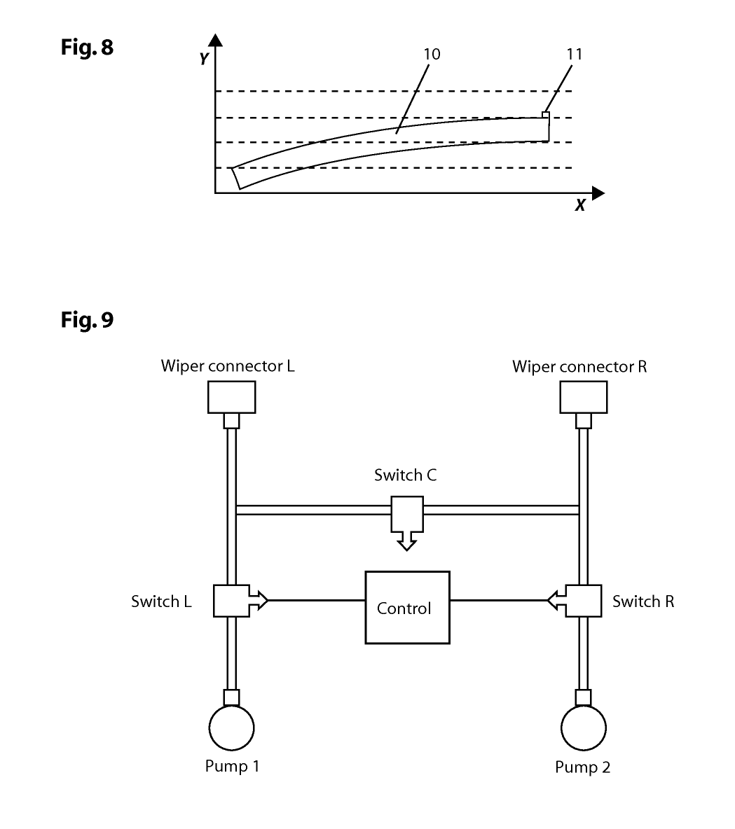

As shown in FIG. 8, the windshield wiper 10 may include an arc or other shape. The shaping may be included to account for curvature of a particular windshield.

Having thus disclosed aspects of the windshield wiper 10, it should be recognized that a variety of additional embodiments may be had and other features may be provided. For example, independent operation of wipers may be desired. The windshield wiper 10 may be used to evenly dispense washer fluid (such as by reversing of pump action).

In some embodiments, the mounts 18 include a suspension system such as is found in the prior art. More specifically, at least one primary armature 4 and often a secondary armature 5 may be included in the mount 18.

In some embodiments, at least one end of the housing 15 is closed (that is, has a sidewall that is orthogonally oriented to the sidewall upon which the grommet 14 is mounted).

In some embodiments, a secondary connector is provided. In these embodiments, the secondary connector may be coupled to another pump, thereby providing for auxiliary or redundant pumping.

In some embodiments, the coupler 11, the connector 16, the pipe 24 and the drain tube 12 are provided as a unitary structure (such as as a product of injection molding). In other embodiments, some of these components are combined (such as the drain tube 12 and the pipe 24).

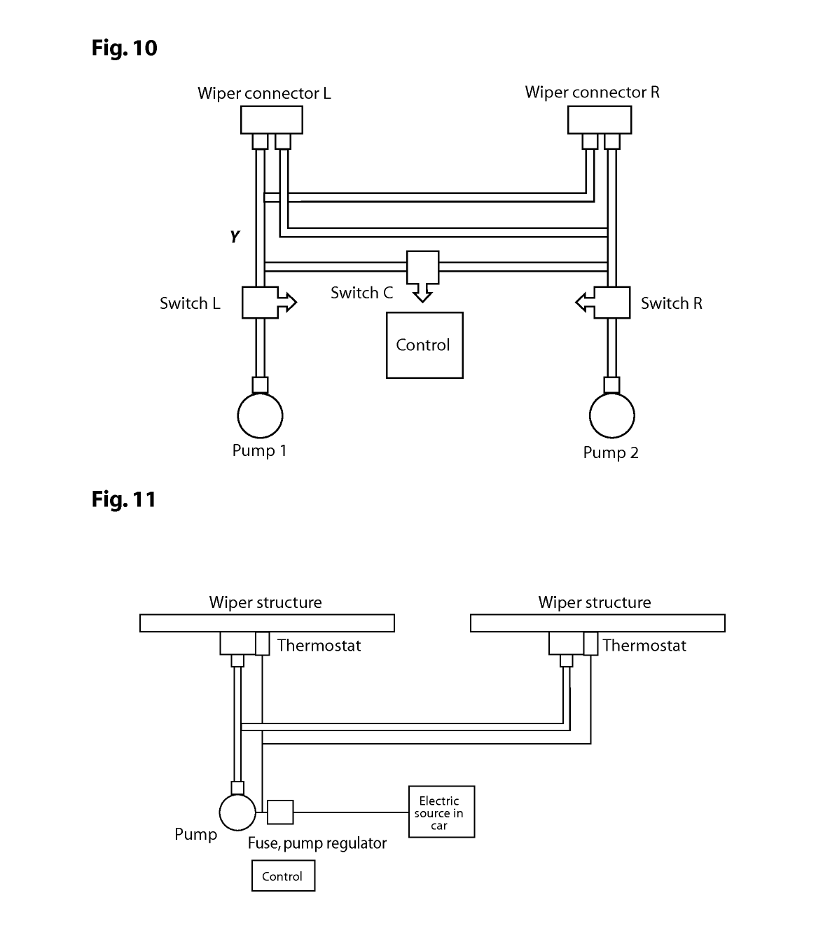

As shown in FIGS. 9, 10 and 11, various other components may be included. These other components generally support the pumping action (redundant pumps may be included), and aspects of control of the windshield wiper 10. Among other things, the system that is provided with the windshield wiper may control parameters such. as pump rates, direction of flow, wiper speed and the like. A control system may provide for automated operation, and may use a variety of sensors (such as a temperature sensor and a rain sensor) as control inputs.

An additional embodiment of the connector 16 is depicted in FIGS. 12, 13 and 14. In FIG. 12, the connector 16 includes a flow design. That is, the flow design connector 16 includes curves and convergence points that are designed to encourage efficiency of flow from the drain tubes 12. In FIG. 13, the flow design connector 16 is shown partially installed in the windshield wiper 10, while in FIG. 14, the flow design connector 16 installation is completed.

In summary, the teachings herein provide for an advanced windshield wiping system. The windshield wiping system provides for efficient wiping action not previously achieved in a variety of inclement conditions.

It should be recognized that the windshield wiping system may be disposed upon any vehicle were visibility during inclement weather conditions is a concern. For example, the windshield wiping system may be installed in an automobile, a truck, a train, an airplane and a boat.

In support of the teachings herein, various additional components may be used that have not been specifically discussed herein. Components include, without limitation, types of pumps, sensors, heating systems, hoses, sources of pressure (negative and positive), valves and the like. Aspects of the windshield wiping system may be controlled by electronics including a digital system and/or an analog system. The system(s) may have components such as a processor, storage media, memory, input, output, communications link, user interfaces, software and firmware programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

The various components that may be used to provide for functionality of the windshield wiping system may serve at least one other function. For example, computer executable instructions may be implemented by a processor provided for controlling other functions within a vehicle.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

It should be recognized that relative terms such as “substantially” do not imply any particular limitations. For example, one element may be of a length, L, while other elements may be substantially of the length, L, and may therefore be longer, shorter or of an equal length. “Segmented” refers to, among other things, an article that is divisible (i.e., divided) into smaller components, which may exhibit some or all of the features of the larger article.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A windshield wiper comprising:
a housing comprising a blade mounted therein;
at least one drain tube comprising a plurality of inlets; and
a coupler for coupling the at least one drain tube to tubing that leads to a pump, wherein the pump is configured for pumping precipitation from the windshield during a variety of inclement weather conditions.

2. The windshield wiper as in claim 1, further comprising at least one heater for providing heat within the housing.

3. The windshield wiper as in claim 2, wherein the heater comprises at least one of a resistive heater and a forced hot air heater.

4. The windshield wiper as in claim 1, wherein the housing comprises a cross section that is one of an inverted U shape and an inverted V shape.

5. The windshield wiper as in claim 1, wherein the at least one drain tube is disposed parallel to and along a length of the blade.

6. The windshield wiper as in claim 1, further comprising at least one grommet disposed on a sidewall of the housing.

7. The windshield wiper as in claim 6, wherein the at least one grommet is segmented along a length of the housing.

8. The windshield wiper as in claim 1, wherein a mount for retaining the blade comprises one of a suspension system and at least one mount coupled to the housing.

9. A system for wiping a windshield, the system comprising:
at least one windshield wiper comprising a housing with a blade mounted therein;
at least one drain tube comprising a plurality of inlets; and a coupler for coupling the at least one drain tube to tubing that leads to a pump; and
a pump for applying a negative pressure to the at least one drain tube and pumping inclement weather precipitation from the windshield.

10. The system as in claim 9, further comprising at least one heater for heating the precipitation.

11. The system as in claim 10, wherein the heater comprises at least one of a resistive heater and a forced hot air heater.

12. The system as in claim 10, further comprising a controller for controlling at least one of a rate of pumping, the heating and a speed of wiping.

13. The system as in claim 12, further comprising at least one of a rain sensor and a temperature sensor, each sensor adapted for providing input to the controller.

14. The system as in claim 9, adapted for operating a first one of the at least one windshield wipers independently of another windshield wiper.

15. The system as in claim 9 further comprising another pump for applying the negative pressure.

16. The system as in claim 9, wherein the pump may be reversed for supplying windshield wash to the at least one drain tube.

17. A vehicle comprising a system for wiping a windshield, the vehicle comprising:
a windshield; and
at least one windshield wiper comprising a housing with a blade mounted therein;
at least one drain tube comprising a plurality of inlets; and a coupler for coupling the at least one drain tube to tubing that leads to a pump; and a pump for applying a negative pressure to the at least one drain tube and pumping precipitation from the windshield;
wherein the at least one windshield wiper is mounted to the vehicle for providing wiping of precipitation from the windshield during operation of the vehicle.

18. The vehicle as in claim 17 comprising one of an automobile, a truck, a train, an airplane and a boat.
